(19) United States
(12) Patent Application Publication
(10) Pub. No.: US 2025/0265275 A1
(43) Pub. Date: Aug. 21, 2025

(54) HYBRID CLUSTERING FOR STREAMING GRAPHS

(71) Applicants: Bytedance Technology Ltd., Grand Cayman (KY); Beijing Zitiao Network Technology Co., Ltd., Beijing (CN)

(72) Inventors: Xin Chen, Los Angeles, CA (US); Jianming Cai, Beijing (CN); Wei Zhuang, Beijing (CN); Simin Xiao, Beijing (CN); Liguang Xie, Los Angeles, CA (US); Jianjun Chen, Los Angeles, CA (US); Rui Shi, Beijing (CN)

(21) Appl. No.: 19/201,416

(22) Filed: May 7, 2025

(51) Int. Cl. G06F 16/28; G06F 16/22

(52) U.S. Cl. CPC G06F 16/285; G06F 16/2264

(57) ABSTRACT

A computing system for implementing hybrid graph clustering is provided. The computing system includes processing circuitry and memory storing instructions that, when executed, cause the processing circuitry to implement a hybrid graph clustering service configured to identify a graph and perform a clustering operation on a plurality of nodes of the graph to thereby generate community IDs for the plurality of nodes. The hybrid graph clustering service is further configured to receive transaction updates from a graph update client, and for each of the transaction updates, perform partial clustering on a subgraph of the graph based on the transaction update to thereby generate partial-clustering-updated community IDs for each node in the subgraph. The hybrid graph clustering service is further configured to perform full clustering on a graph copy based on the transaction updates in a full clustering queue to thereby generate full-clustering-updated community IDs for each node in the graph.

### BACKGROUND

Graphs are an effective way to represent real-world networks, such as social media platforms and financial systems. Graph clustering algorithms identify communities of interrelated entities within networks. The results of clustering algorithms can be used in areas such as recommendation systems and risk evaluation. Graphs are often dynamic, with nodes and edges continuously modified by a stream of updates, and thus graph queries must be processed concurrently with graph updates. Improving the latency of graph queries on dynamic graphs remains a challenge.

### SUMMARY

According to one aspect of the present disclosure, a computing system is provided including processing circuitry and memory storing instructions that, when executed, cause the processing circuitry to implement a hybrid graph clustering service. The hybrid graph clustering service is configured to receive transaction updates from a graph update client, each transaction update indicating a change in state of a subgraph of a graph, wherein the graph is a streaming graph that includes a plurality of nodes and a plurality of edges, each of the plurality of nodes representing an entity in a network. For each of the transaction updates, the hybrid graph clustering service is configured to send the transaction update to a full clustering queue, perform partial clustering on the subgraph of the graph based on the transaction update to thereby generate partial-clustering-updated community IDs for each node in the subgraph, and update a community list with the partial-clustering-updated community IDs for each node in the subgraph, wherein the community list includes each respective node and an associated community ID of a community to which the respective node was assigned by a clustering operation. The hybrid graph clustering service is further configured to output the updated community list including the partial-clustering-updated community IDs. The hybrid graph clustering service is further configured to perform full clustering on the graph copy based on the transaction updates in the full clustering queue to thereby generate full-clustering-updated community IDs for each node in the graph and update the community list with the full-clustering-updated community IDs for each node in the graph.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a schematic view of a computing system for implementing a hybrid graph clustering service, according to an example of the present disclosure.

FIG. 2 is a schematic view of a node deletion and insertion scheme of the computing system of FIG. 1.

FIG. 3 is a schematic view of a service transition scheme of the computing system of FIG. 1.

FIG. 4 is a flowchart of a method for performing hybrid graph clustering, according to an example of the present disclosure.

FIG. 5 is a schematic view of an example computing environment in which the hybrid graph clustering service can be implemented.

### DETAILED DESCRIPTION

Graph clustering is a technique used for grouping nodes in a graph into communities. Clustering has been applied to several systems, including community detection in social networks, and risk evaluation for unauthorized transactions, fraud detection, etc. in financial networks. In some applications, where graphs change in real time, such as streaming graphs, graph clustering must be performed concurrently with graph updates. For example, in financial networks, clustering is performed on graphs that are continuously updated with a stream of user transactions. In such applications, it is critical that graph clustering is computed with low latency. Parallelization has been used to speed up graph clustering. However, existing methods that use parallelization are unable to provide clustering results on streaming graphs with sufficiently low latency, such as under 100 ms latency.

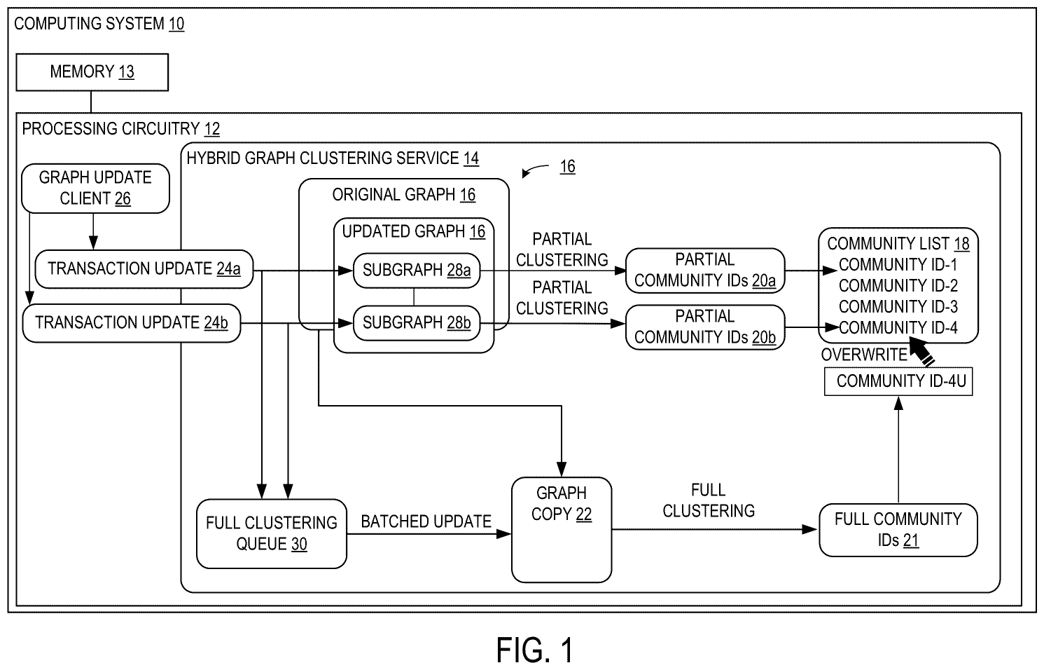

FIG. 1 schematically depicts a computing system 10. Computing system 10 includes processing circuitry 12 and memory storing instructions 13 that, when executed, cause the processing circuitry 12 to implement a hybrid graph clustering service 14. The hybrid graph clustering service is configured to receive transaction updates 24a-b from a graph update client 26, each transaction update 24 indicating a change in state of a subgraph 28 of a graph 16. The graph 16 is a streaming graph that is updated via the transaction updates and includes a plurality of nodes and a plurality of edges, each of the plurality of nodes representing an entity in a network. For example, the network can be an online payment service, the nodes of the graph 16 can represent users of the online payment service, and the edges of the graph 16 can represent information relating to transactions between users. The graph 16 can represent other types of networks such as online social networks. Each of the plurality of nodes is labeled with a string. For example, the string can be a username, phone number, card number, or other information associated with the respective entity in the network.

For each of the transaction updates 24a-b, the hybrid graph clustering service 14 is further configured to perform partial clustering on the subgraph 28 of the graph 16 based on the transaction update 24, to thereby generate partial-clustering-updated community IDs 20 for each node in the subgraph 28. The partial clustering can comprise updating the nodes and the edges of the subgraph 28 of the graph 16 based on the transaction update 24 and computing the partial-clustering-updated community IDs 20 based on the subgraph 28 of the graph 16 using a Louvain community detection algorithm. Other clustering algorithms can be used, such as the Leiden algorithm. Synchronization mechanisms such as locks can be used for updating the graph 16, so that each partial clustering operation is performed on a consistent graph. The hybrid graph clustering service 14 is further configured to update a community list 18 with the partial-clustering-updated community IDs 20 for each node in the subgraph 28. The community list 18 includes each respective node of the graph 16 and an associated community ID of a community to which the respective node was assigned by a clustering operation. The community is a collection of nodes that are more densely connected to each other than to nodes outside the community. The hybrid graph clustering service 14 is further configured to output the updated community list 18 including the partial-clustering-updated community IDs 20, as a clustering result. The hybrid graph clustering service 14 is further configured to send the transaction update 24 to a full clustering queue 30, to be used for performing a batched update on a graph copy 22.

The hybrid graph clustering service 14 is further configured to perform full clustering on the graph copy 22 based on the transaction updates 24a-b in the full clustering queue 30, to thereby generate full-clustering-updated community IDs 21 for each node in the graph 16, which can be used to update the clustering result. The graph copy 22 is a copy of the graph 16 and can be generated each time an iteration of full clustering is completed. The full clustering can comprise performing a batched update of the nodes and the edges of the graph copy 22 based on the transaction updates 24a-b of the full clustering queue 30 and computing the full-clustering-updated community IDs 21 based on the graph copy 22 using the Louvain community detection algorithm. The full clustering operation can employ parallelization for enhanced efficiency. For example, a Ligra graph processing framework can be used to compute connected components of the graph copy 22 and the Louvain algorithm can be applied to each of the connected components in parallel. In addition, the partial clustering and the full clustering can be performed concurrently, and in parallel. In other words, the hybrid graph clustering service 14 can perform partial clustering to generate partial-clustering-updated community IDs 20a-b, while concurrently performing full clustering on the graph copy 22. Hybrid clustering allows low latency clustering results to be obtained via partial clustering, while the full clustering updates maintain the quality of the clustering results.

When an iteration of full clustering is completed, the hybrid graph clustering service 14 is further configured to update the community list 18 with the full-clustering-updated community IDs 21 for each node in the graph 16. The updates to the community list 18 can be implemented without synchronization mechanisms such as locks. Each full clustering or partial clustering update can be allowed to overwrite the values in the community list 18.

The processing circuitry 12 is further configured to initialize the hybrid graph clustering service at least in part by reading the graph 16 from a distributed file system and performing the clustering operation on the graph 16 to thereby generate the community list 18. The clustering operation can be implemented using the Louvain community detection algorithm or other community detection algorithm such as the Leiden algorithm, etc.

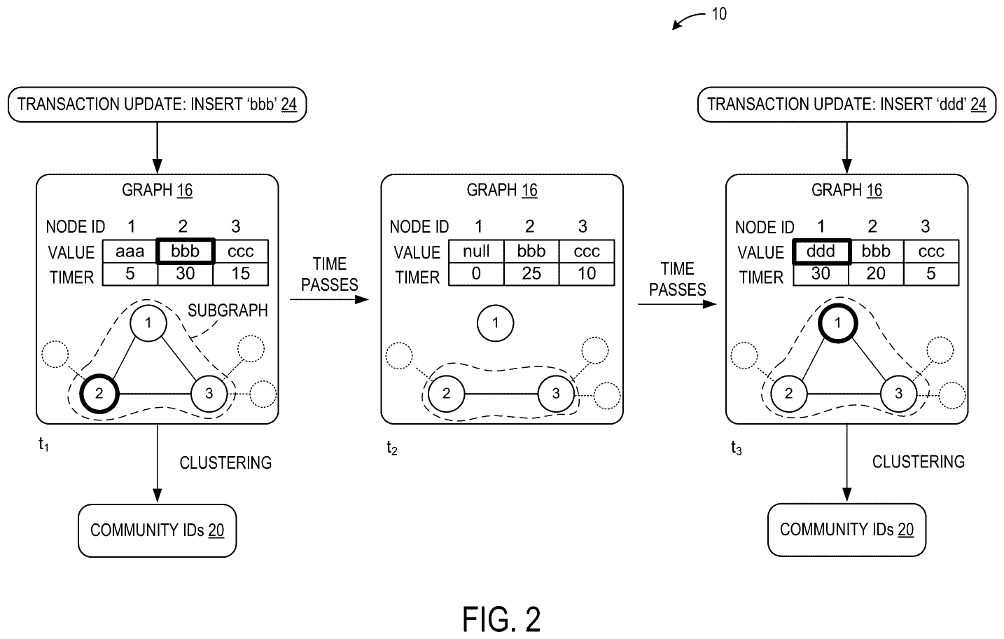

To manage memory allocation, a node deletion and insertion scheme can be implemented for computing system 10. As shown in FIG. 2, each node of the graph 16 can have a timer or counter that initializes when the node is updated, and after a preset time or count has elapsed, the node can be deleted. Each node can be mapped to a respective memory container and when the transaction update indicates adding new nodes to the graph 16, the new nodes can be mapped to the memory containers whose respective nodes have been deleted. For example, each of the nodes can be labeled with an integer node ID corresponding to the memory container to which the node is assigned. Additionally, each node can have a respective string label and timer. In the example of FIG. 2, when the node is updated, the respective timer is set to 30. When the timer becomes zero, the node is deleted and the respective memory container becomes available. When the transaction update indicates that an additional entity labeled with a value such as the string ‘ddd’ is added to the network, the additional entity is assigned to the available memory container. From right to left in FIG. 2, it will therefore be appreciated, node 1 within subgraph 1-2-3 (denoted by a dashed line) of the larger graph 16 is set to null value, and its edges to other nodes are removed when the time hits zero, thereby resulting in shrinking of the subgraph to nodes 2-3 in the middle depiction. After further passing of time, a new node is added with the node ID 1 and a value ‘ddd’ and with edges that link to nodes 2 and 3. The subgraph then expands to 1-2-3. This node deletion and insertion scheme removes the need for memory garbage collection, thus reducing the overhead expenses associated with memory management.

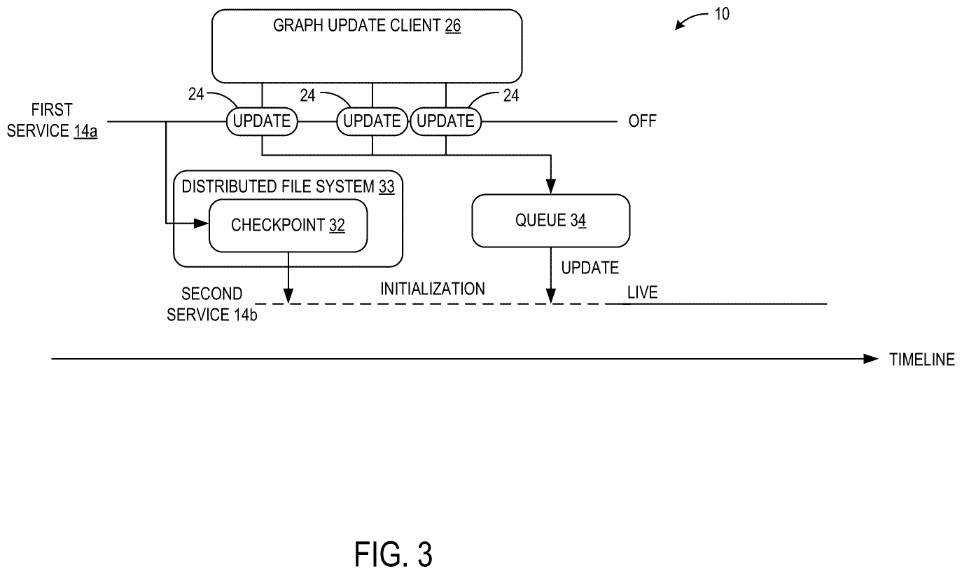

The graph 16 and the community list 18 are periodically written to the distributed file system 33, to generate checkpoint files 32 from which the hybrid graph clustering service 14 can be restarted. FIG. 3 shows a schematic view of computing system 10 transitioning from a first hybrid graph clustering service 14a to a second hybrid graph clustering service 14b. During transitioning from a first graph clustering service 14a to a second graph clustering service 14b, the processing circuitry 12 is further configured to implement the below steps. First, the second graph clustering service 14b is initialized using graph metadata loaded from the checkpoint file 32. During the initialization of the second graph clustering service 14b, the transaction updates 24 received from the graph update client 26 are sent to a queue 34. Then the second graph clustering service 14b is updated with the transaction updates 24 in the queue 34. Finally, the second graph clustering service 14b is started, and the first graph clustering 14a service is turned off. The first and second graph clustering services can be two instances of the same service on different computers, for example, or different clustering services that cluster according to different clustering parameters. This service transition scheme promotes the smooth transition between two services without loss of data. During the transition, the service remains available to the client, so that the service is undisrupted from the client's perspective.

The processing circuitry 12 can be further configured to perform a runtime graph query on the updated community list 18 to thereby compute a graph query result and output the graph query result. The runtime graph query can be a risk query, and a requested action by a user can be blocked based on the graph query result for the risk query. In one example, the risk query can be a risk query to determine a risk of fraud associated with a transaction. In another example the risk query can be a risk of non-compliance with platform policy, such as compliance with local laws and regulations of a jurisdiction, or compliance with published community standards for a platform or an end user license agreement of a platform, etc.

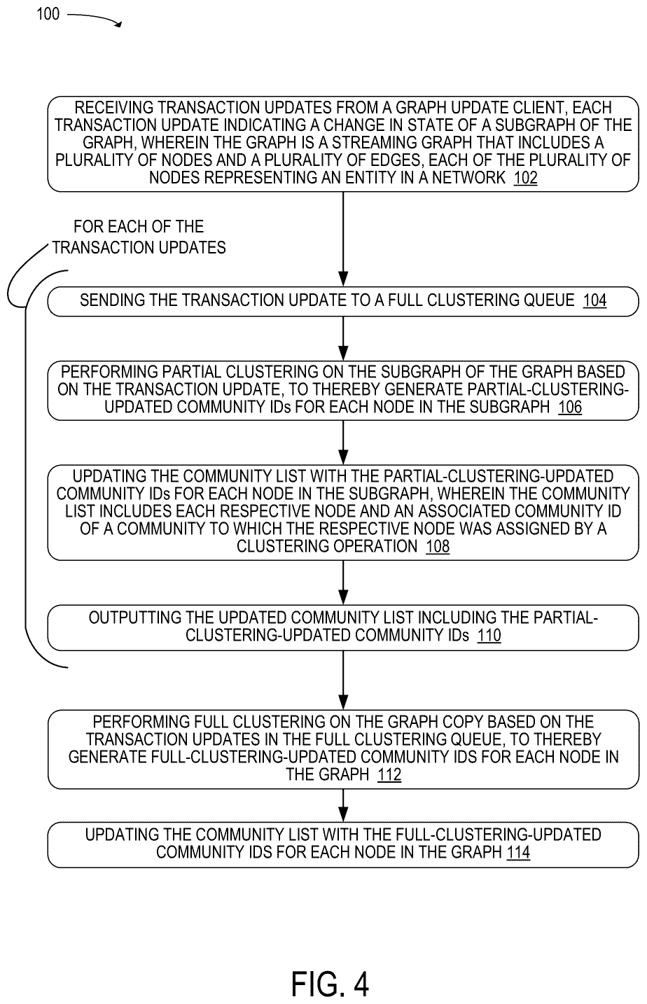

FIG. 4 shows a flowchart of a computerized method 100, according to one example implementation of the present disclosure. Method 100 can be implemented using the hardware and software components of computing system 10 described above, or other suitable hardware and software components, as desired. At step 102, method 100 includes receiving the transaction updates from a graph update client, each transaction update indicating a change in state of a subgraph of a graph. The graph is a streaming graph that includes a plurality of nodes and a plurality of edges, each of the plurality of nodes representing an entity in a network.

At step 104, method 100 includes, for each transaction update, sending the transaction update to a full clustering queue. At step 106, method 100 includes, for each transaction update, performing partial clustering on the subgraph of the graph based on the transaction update, to thereby generate partial-clustering-updated community IDs for each node in the subgraph. The partial clustering can comprise updating the nodes and the edges of the subgraph of the graph based on the transaction update and computing the partial-clustering-updated community IDs based on the subgraph of the graph using a Louvain community detection algorithm or other clustering algorithm. At step 108, method 100 includes, for each transaction update, updating a community list with the partial-clustering-updated community IDs for each node in the subgraph, wherein the community list includes each respective node and an associated community ID of a community to which the respective node was assigned by a clustering operation. At step 110, method 100 includes, for each transaction update, outputting the updated community list including the partial-clustering-updated community IDs.

At step 112, method 100 includes performing full clustering on a graph copy based on the transaction updates in the full clustering queue, to thereby generate full-clustering-updated community IDs for each node in the graph. The graph copy is a copy of the graph. The full clustering can comprise performing a batched update of the nodes and the edges of the graph copy based on the transaction updates of the full clustering queue and computing the full-clustering-updated community IDs based on the graph copy using the Louvain community detection algorithm. At step 114, method 100 includes updating the community list with the full-clustering-updated community IDs for each node in the graph. The partial clustering and the full clustering can be performed concurrently.

To initialize the graph and the community list, the graph can be read from a distributed file system and the clustering operation can be performed on the graph to thereby generate the community list. The initialization only need to be performed once. Each node can have a timer or counter that initializes when the node is updated, and after a preset time or count has elapsed, the node can be marked for deletion. Each node can be mapped to a respective memory container and when the transaction update indicates adding new nodes to the graph, the new nodes can be mapped to the memory containers whose respective nodes have been deleted. The graph and the community list can be periodically written to the distributed file system to generate checkpoints from which a hybrid graph clustering service can be restarted.

As described herein, by implementing a hybrid graph clustering service, low latency graph clustering is achieved with high accuracy. The system can achieve graph clustering with superior latency, such as under 100 ms latency on billion-node graphs. In addition, a node insertion and deletion scheme is implemented, which solves memory leakage issues, further improving the efficiency of the system. Graph checkpointing and a service transition scheme are introduced to improve fault tolerance.

In some embodiments, the methods and processes described herein may be tied to a computing system of one or more computing devices. In particular, such methods and processes may be implemented as a computer-application program or service, an application-programming interface (API), a library, and/or other computer-program product.

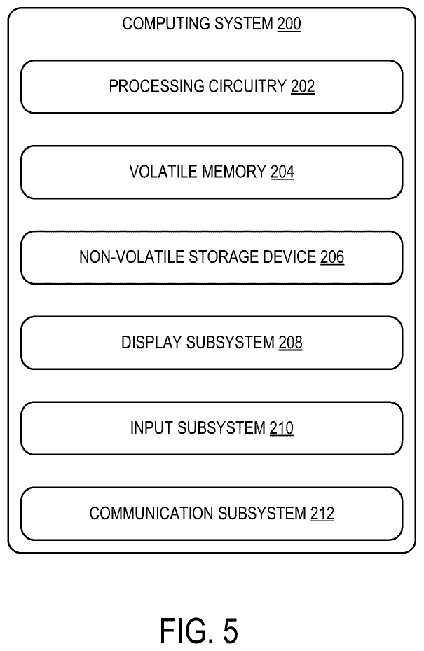

FIG. 5 schematically shows a non-limiting embodiment of a computing system 200 that can enact one or more of the methods and processes described above. Computing system 200 is shown in simplified form. Computing system 200 may embody the computing system 10 described above and illustrated in FIG. 1. Components of computing system 200 may be included in one or more personal computers, server computers, tablet computers, home-entertainment computers, network computing devices, video game devices, mobile computing devices, mobile communication devices (e.g., smartphone), and/or other computing devices, and wearable computing devices such as smart wristwatches and head mounted augmented reality devices.

Computing system 200 includes a logic processor 202 volatile memory 204, and a non-volatile storage device 206. Computing system 200 may optionally include a display subsystem 208, input subsystem 210, communication subsystem 212, and/or other components not shown in FIG. 5.

Logic processor 202 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors configured to execute software instructions. Additionally or alternatively, the logic processor may include one or more hardware logic circuits or firmware devices configured to execute hardware-implemented logic or firmware instructions. Processors of the logic processor 202 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines, it will be understood.

Non-volatile storage device 206 includes one or more physical devices configured to hold instructions executable by the logic processors to implement the methods and processes described herein. When such methods and processes are implemented, the state of non-volatile storage device 206 may be transformed—e.g., to hold different data.

Non-volatile storage device 206 may include physical devices that are removable and/or built in. Non-volatile storage device 206 may include optical memory, semiconductor memory, and/or magnetic memory, or other mass storage device technology. Non-volatile storage device 206 may include nonvolatile, dynamic, static, read/write, read-only, sequential-access, location-addressable, file-addressable, and/or content-addressable devices. It will be appreciated that non-volatile storage device 206 is configured to hold instructions even when power is cut to the non-volatile storage device 206.

Volatile memory 204 may include physical devices that include random access memory. Volatile memory 204 is typically utilized by logic processor 202 to temporarily store information during processing of software instructions. It will be appreciated that volatile memory 204 typically does not continue to store instructions when power is cut to the volatile memory 204.

Aspects of logic processor 202, volatile memory 204, and non-volatile storage device 206 may be integrated together into one or more hardware-logic components. Such hardware-logic components may include field-programmable gate arrays (FPGAs), program- and application-specific integrated circuits (PASIC/A SICs), program- and application-specific standard products (PSSP/A SSPs), system-on-a-chip (SOC), and complex programmable logic devices (CPLDs), for example.

The terms “module,” “program,” and “engine” may be used to describe an aspect of computing system 200 typically implemented in software by a processor to perform a particular function using portions of volatile memory, which function involves transformative processing that specially configures the processor to perform the function. Thus, a module, program, or engine may be instantiated via logic processor 202 executing instructions held by non-volatile storage device 206, using portions of volatile memory 204. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 208 may be used to present a visual representation of data held by non-volatile storage device 206. The visual representation may take the form of a graphical user interface (GUI). As the herein described methods and processes change the data held by the non-volatile storage device, and thus transform the state of the non-volatile storage device, the state of display subsystem 208 may likewise be transformed to visually represent changes in the underlying data. Display subsystem 208 may include one or more display devices utilizing virtually any type of technology. Such display devices may be combined with logic processor 202, volatile memory 204, and/or non-volatile storage device 206 in a shared enclosure, or such display devices may be peripheral display devices.

When included, input subsystem 210 may comprise or interface with one or more user-input devices such as a keyboard, mouse, touch screen, camera, or microphone.

When included, communication subsystem 212 may be configured to communicatively couple various computing devices described herein with each other, and with other devices. Communication subsystem 212 may include wired and/or wireless communication devices compatible with one or more different communication protocols. As non-limiting examples, the communication subsystem may be configured for communication via a wired or wireless local- or wide-area network, broadband cellular network, etc. In some embodiments, the communication subsystem may allow computing system 200 to send and/or receive messages to and/or from other devices via a network such as the Internet.

The following paragraphs discuss several aspects of the present disclosure. According to one aspect of the present disclosure, a computing system is provided, including processing circuitry and memory storing instructions that, during execution, cause the processing circuitry to implement a hybrid graph clustering service. The hybrid graph clustering service is configured to receive transaction updates from a graph update client. Each transaction update indicates a change in state of a subgraph of a graph, wherein the graph is a streaming graph that includes a plurality of nodes and a plurality of edges, each of the plurality of nodes representing an entity in a network. For each of the transaction updates, the hybrid graph clustering service is configured to send the transaction update to a full clustering queue. For each of the transaction updates, the hybrid graph clustering service is further configured to perform partial clustering on the subgraph of the graph based on the transaction update, to thereby assign partial-clustering-updated community IDs to each node in the subgraph. For each of the transaction updates, the hybrid graph clustering service is further configured to update a community list with the partial-clustering-updated community IDs for each node in the subgraph, wherein the community list includes each respective node and an associated community ID of a community to which the respective node was assigned by a clustering operation. For each of the transaction updates, the hybrid graph clustering service is further configured to output the updated community list including the partial-clustering-updated community IDs. The hybrid graph clustering service is further configured to perform full clustering on a graph copy based on the transaction updates in the full clustering queue, to thereby generate full-clustering-updated community IDs for each node in the graph and wherein the graph copy is a copy of the graph. The hybrid graph clustering service is further configured to update the community list with the full-clustering-updated community IDs for each node in the graph. The above features may have the technical effect of integrating full clustering and partial clustering operations into a hybrid clustering service, to thereby provide real-time clustering results on streaming graphs.

According to this aspect, the processing circuitry is further configured to initialize the hybrid graph clustering service at least in part by reading the graph from a distributed file system and performing the clustering operation on the graph to thereby generate the community list. The above features may have the technical effect of loading a stored graph into volatile memory and performing an initial clustering operation on the graph.

According to this aspect, the partial clustering comprises updating the nodes and the edges of the subgraph of the graph based on the transaction update and computing the partial-clustering-updated community IDs based on the subgraph of the graph using a Louvain community detection algorithm. The above features may have the technical effect of performing clustering on nodes of the graph related to transaction updates, to thereby generate updated community IDs.

According to this aspect, the full clustering comprises performing a batched update of the nodes and the edges of the graph copy based on the transaction updates of the full clustering queue and computing the full-clustering-updated community IDs based on the graph copy using the Louvain community detection algorithm. The above features may have the technical effect of performing synchronous clustering on the full graph to generate updated community IDs.

According to this aspect, the partial clustering and the full clustering are performed concurrently. The above features may have the technical effect of providing partial clustering updates while the full clustering is being performed.

According to this aspect, each node has a timer or counter that initializes when the node is updated, and after a preset time or count has elapsed, the node is marked for deletion. The above features may have the technical effect of removing inactive nodes from memory.

According to this aspect, each node is mapped to a respective memory container and when the transaction update indicates adding new nodes to the graph, the new nodes are mapped to the memory containers whose respective nodes have been deleted. The above features may have the technical effect of assigning new nodes to available regions of memory.

According to this aspect, the graph and the community list are periodically written to the distributed file system. The above features may have the technical effect of generating checkpoint files from which the hybrid graph clustering service can be restarted.

According to this aspect, the processing circuitry is further configured to transition from a first graph clustering service to a second graph clustering service, at least in part by initializing the second graph clustering service using graph metadata loaded from a checkpoint file, sending to a queue the transaction updates received from the graph update client during initialization of the second graph clustering service, updating the second graph clustering service with the transaction updates in the queue, and starting the second graph clustering service and turning off the first graph clustering service. The above features may have the technical effect of merging the latest graph data of a first graph clustering service with a second graph clustering service.

According to this aspect, the processing circuitry is further configured to perform a runtime graph query on the updated community list to thereby compute a graph query result and output the graph query result. The above features may have the technical effect of computing a graph query result based on the clustering results.

According to this aspect, the runtime graph query is a risk query, and the processing circuitry is further configured to block a requested action by a user based on the graph query result for the risk query. The above features may have the technical effect of blocking a requested action based on the level of risk indicated by a risk query.

According to another aspect of the present disclosure, a computerized method is provided. The method includes receiving transaction updates from a graph update client, each transaction update indicating a change in state of a subgraph of a graph, wherein the graph is a streaming graph that includes a plurality of nodes and a plurality of edges, each of the plurality of nodes representing an entity in a network. For each of the transaction updates, the method further includes sending the transaction update to a full clustering queue, performing partial clustering on the subgraph of the graph based on the transaction update, to thereby generate partial-clustering-updated community IDs for each node in the subgraph, and updating a community list with the partial-clustering-updated community IDs for each node in the subgraph, wherein the community list includes each respective node and an associated community ID of a community to which the respective node was assigned by a clustering operation. The method further includes outputting the updated community list including the partial-clustering-updated community IDs. The method further includes performing full clustering on a graph copy based on the transaction updates in the full clustering queue, to thereby generate full-clustering-updated community IDs for each node in the graph and wherein the graph copy is a copy of the graph, and updating the community list with the full-clustering-updated community IDs for each node in the graph. The above features may have the technical effect of integrating full clustering and partial clustering operations into a hybrid clustering service, to thereby provide real-time clustering results on streaming graphs.

According to this aspect, the graph is read from a distributed file system and the clustering operation is performed on the graph to generate the community list. The above features may have the technical effect of loading a stored graph into volatile memory and performing an initial clustering operation on the graph.

According to this aspect, the partial clustering comprises updating the nodes and the edges of the subgraph of the graph based on the transaction update and computing the partial-clustering-updated community IDs based on the subgraph of the graph using a Louvain community detection algorithm. The above features may have the technical effect of performing clustering on nodes of the graph related to transaction updates, to thereby generate updated community IDs.

According to this aspect, the full clustering comprises performing a batched update of the nodes and the edges of the graph copy based on the transaction updates of the full clustering queue and computing the full-clustering-updated community IDs based on the graph copy using the Louvain community detection algorithm. The above features may have the technical effect of performing synchronous clustering on the full graph to generate updated community IDs.

According to this aspect, the partial clustering and the full clustering are performed concurrently. The above features may have the technical effect of providing partial clustering updates while the full clustering is being performed.

According to this aspect, each node has a timer or counter that initializes when the node is updated, and after a preset time or count has elapsed, the node is marked for deletion. The above features may have the technical effect of removing inactive nodes from memory.

According to this aspect, each node is mapped to a respective memory container and when the transaction update indicates adding new nodes to the graph, the new nodes are mapped to the memory containers whose respective nodes have been deleted. The above features may have the technical effect of assigning new nodes to available regions of memory.

According to this aspect, the graph and the community list are periodically written to the distributed file system. The above features may have the technical effect of generating checkpoint files from which the hybrid graph clustering service can be restarted.

According to another aspect of the present disclosure, a computing system is provided, including processing circuitry and memory storing instructions that, when executed, cause the processing circuitry to implement a hybrid graph clustering service of a social network. The hybrid graph clustering service is configured to identify a graph including a plurality of nodes and a plurality of edges, each of the plurality of nodes representing an entity in the social network, generate a graph copy, receive transaction updates from a graph update client, each transaction update indicating a change in state of a subgraph of the graph. The hybrid graph clustering service is further configured to, for each of the transaction updates, send the transaction update to a full clustering queue, perform partial clustering on the subgraph of the graph based on the transaction update, and output a clustering result of the partial clustering. The hybrid graph clustering service is further configured to perform full clustering on the graph copy based on the transaction updates in the full clustering queue, wherein the full clustering and partial clustering are performed in parallel, and update the clustering result based on a result of the full clustering. The above features may have the technical effect of integrating full clustering and partial clustering operations into a hybrid clustering service, to thereby provide real-time clustering results on streaming graphs.

“And/or” as used herein is defined as the inclusive or V, as specified by the following truth table:

| A | B | A ∨ B |
|---|---|---|
| True | True | True |
| True | False | True |
| False | True | True |
| False | False | False |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system, comprising:
processing circuitry and memory storing instructions that, when executed, cause the processing circuitry to implement a hybrid graph clustering service configured to:
receive transaction updates from a graph update client, each transaction update indicating a change in state of a subgraph of a graph, wherein the graph is a streaming graph that includes a plurality of nodes and a plurality of edges, each of the plurality of nodes representing an entity in a network;
for each of the transaction updates:
send the transaction update to a full clustering queue;
perform partial clustering on the subgraph of the graph based on the transaction update, to thereby assign partial-clustering-updated community IDs to each node in the subgraph;
update a community list with the partial-clustering-updated community IDs for each node in the subgraph, wherein the community list includes each respective node and an associated community ID of a community to which the respective node was assigned by a clustering operation; and
output the updated community list including the partial-clustering-updated community IDs;
perform full clustering on a graph copy based on the transaction updates in the full clustering queue, to thereby generate full-clustering-updated community IDs for each node in the graph and wherein the graph copy is a copy of the graph; and
update the community list with the full-clustering-updated community IDs for each node in the graph.

2. The computing system of claim 1, wherein the processing circuitry is further configured to initialize the hybrid graph clustering service at least in part by:
reading the graph from a distributed file system; and
performing the clustering operation on the graph to thereby generate the community list.

3. The computing system of claim 1, wherein the partial clustering comprises updating the nodes and the edges of the subgraph of the graph based on the transaction update and computing the partial-clustering-updated community IDs based on the subgraph of the graph using a Louvain community detection algorithm.

4. The computing system of claim 1, wherein the full clustering comprises performing a batched update of the nodes and the edges of the graph copy based on the transaction updates of the full clustering queue and computing the full-clustering-updated community IDs based on the graph copy using the Louvain community detection algorithm.

5. The computing system of claim 1, wherein the partial clustering and the full clustering are performed concurrently.

6. The computing system of claim 1, wherein each node has a timer or counter that initializes when the node is updated, and after a preset time or count has elapsed, the node is marked for deletion.

7. The computing system of claim 1, wherein each node is mapped to a respective memory container and when the transaction update indicates adding new nodes to the graph, the new nodes are mapped to the memory containers whose respective nodes have been deleted.

8. The computing system of claim 1, wherein the graph and the community list are periodically written to the distributed file system.

9. The computing system of claim 1, wherein the processing circuitry is further configured to transition from a first graph clustering service to a second graph clustering service, at least in part by:
initializing the second graph clustering service using graph metadata loaded from a checkpoint file;
sending to a queue the transaction updates received from the graph update client during initialization of the second graph clustering service;
updating the second graph clustering service with the transaction updates in the queue; and
starting the second graph clustering service and turning off the first graph clustering service.

10. The computing system of claim 1, wherein the processing circuitry is further configured to perform a runtime graph query on the updated community list to thereby compute a graph query result and output the graph query result.

11. The computing system of claim 10, wherein the runtime graph query is a risk query, and the processing circuitry is further configured to:
block a requested action by a user based on the graph query result for the risk query.

12. A computerized method comprising:
receiving transaction updates from a graph update client, each transaction update indicating a change in state of a subgraph of a graph, wherein the graph is a streaming graph that includes a plurality of nodes and a plurality of edges, each of the plurality of nodes representing an entity in a network;
for each of the transaction updates:
sending the transaction update to a full clustering queue;
performing partial clustering on the subgraph of the graph based on the transaction update, to thereby generate partial-clustering-updated community IDs for each node in the subgraph;
updating a community list with the partial-clustering-updated community IDs for each node in the subgraph, wherein the community list includes each respective node and an associated community ID of a community to which the respective node was assigned by a clustering operation; and
outputting the updated community list including the partial-clustering-updated community IDs;
performing full clustering on a graph copy based on the transaction updates in the full clustering queue, to thereby generate full-clustering-updated community IDs for each node in the graph and wherein the graph copy is a copy of the graph; and
updating the community list with the full-clustering-updated community IDs for each node in the graph.

13. The method of claim 12, wherein the graph is read from a distributed file system and the clustering operation is performed on the graph to generate the community list.

14. The method of claim 12, wherein the partial clustering comprises updating the nodes and the edges of the subgraph of the graph based on the transaction update and computing the partial-clustering-updated community IDs based on the subgraph of the graph using a Louvain community detection algorithm.

15. The method of claim 12, wherein the full clustering comprises performing a batched update of the nodes and the edges of the graph copy based on the transaction updates of the full clustering queue and computing the full-clustering-updated community IDs based on the graph copy using the Louvain community detection algorithm.

16. The method of claim 12, wherein the partial clustering and the full clustering are performed concurrently.

17. The method of claim 12, wherein each node has a timer or counter that initializes when the node is updated, and after a preset time or count has elapsed, the node is marked for deletion.

18. The method of claim 12, wherein each node is mapped to a respective memory container and when the transaction update indicates adding new nodes to the graph, the new nodes are mapped to the memory containers whose respective nodes have been deleted.

19. The method of claim 12, wherein the graph and the community list are periodically written to the distributed file system.

20. A computing system, comprising:
processing circuitry and memory storing instructions that, when executed, cause the processing circuitry to implement a hybrid graph clustering service of a social network configured to:
identify a graph comprising a plurality of nodes and a plurality of edges, each of the plurality of nodes representing an entity in the social network;
generate a graph copy;
receive transaction updates from a graph update client, each transaction update indicating a change in state of a subgraph of the graph;
for each of the transaction updates:
send the transaction update to a full clustering queue;
perform partial clustering on the subgraph of the graph based on the transaction update;
output a clustering result of the partial clustering;
perform full clustering on the graph copy based on the transaction updates in the full clustering queue, wherein the full clustering and partial clustering are performed in parallel; and
update the clustering result based on a result of the full clustering.
